(19) United States
(12) Patent Application Publication
(10) Pub. No.: US 2026/0016213 A1
(43) Pub. Date: Jan. 15, 2026

(54) BATTERY-POWERED PORTABLE COOLER

(71) Applicant: MILWAUKEE ELECTRIC TOOL CORPORATION, Brookfield, WI (US)

(72) Inventors: Adam J. Sargis, Mount Pleasant, WI (US); Benjamin D. Gabbard, Wauwatosa, WI (US); Jacob D. Hadfield, Mukwonago, WI (US); Michael D. Huh, Milwaukee, WI (US); Austin A. Borkowski, Greendale, WI (US)

(21) Appl. No.: 19/264,970

(22) Filed: Jul. 10, 2025

Related U.S. Application Data
(60) Provisional application No. 63/670,249, filed on Jul. 12, 2024.
(60) Provisional application No. 63/791,087, filed on Apr. 18, 2025.

(51) Int. Cl. F25D 11/00; F25D 17/02; F25D 17/06; F25D 21/14; F25D 23/02; F25D 31/00; H01M 50/247; H01M 50/264; H01M 50/271

(52) U.S. Cl. CPC F25D 11/003; F25D 17/02; F25D 17/06; F25D 21/14; F25D 23/026; F25D 23/028; F25D 31/007; H01M 50/247; H01M 50/264; H01M 50/271; F25D 2300/00; F25D 2317/0664; F25D 2321/142; F25D 2323/0011; F25D 2400/12; F25D 2400/36; F25D 2400/38; F25D 2700/06; H01M 2220/30

(57) ABSTRACT

A battery-powered portable cooler includes a main body with a tub for receiving contents, a cooling compartment, and insulation at least partly surrounding the tub. A lid opens and closes to selectively provide access to the tub. A wheel supports the main body on a support surface. A refrigeration system includes a compressor, a condenser, and an expansion valve, all located in the cooling compartment, and an evaporator including evaporator coils at least partly surrounding the tub to conductively cool the contents of the tub. An electronic control unit is operably connected to a user interface to receive input from the user interface and control operation of the refrigeration system. A battery pack mates with a battery receptacle along a battery insertion axis in a direction toward the tub. The battery pack provides electrical power to the electronic control unit, the user interface, and the refrigeration system.

### CROSS-REFERENCE TO RELATED APPLICATION

This application claims priority to U.S. Provisional Patent Application No. 63/791,087 filed on Apr. 18, 2025 and U.S. Provisional Patent Application No. 63/670,249 filed on Jul. 12, 2024, the entire contents of both of which are incorporated herein by reference.

### FIELD OF THE INVENTION

The present invention relates to portable coolers.

### BACKGROUND OF THE INVENTION

Portable coolers may keep items such as food and drinks cooler than an ambient temperature.

### SUMMARY OF THE INVENTION

The present invention provides, in one aspect, a battery-powered portable cooler including a main body including a tub for receiving contents, a cooling compartment, and insulation at least partly surrounding the tub. The battery-powered portable cooler includes a lid configured to open and close to selectively provide access to the tub. The battery-powered portable cooler includes a wheel supporting the main body on a support surface. The battery-powered portable cooler includes a user interface. The battery-powered portable cooler includes a refrigeration system including a compressor located in the cooling compartment, a condenser located in the cooling compartment, an expansion valve located in the cooling compartment, and an evaporator including evaporator coils at least partly surrounding the tub to conductively cool the contents of the tub. The battery-powered portable cooler includes an electronic control unit operably connected to the user interface. The electronic control unit receives input from the user interface and controls operation of the refrigeration system. The battery-powered portable cooler includes a battery receptacle and a battery pack for mating with the battery receptacle. The battery pack provides electrical power to the electronic control unit, the user interface, and the refrigeration system. The battery-powered portable cooler includes a fan coupled to a sidewall of the tub. The fan is controlled by the electronic control unit and is operable to generate a cooling airflow by forced convection within the tub.

The present invention provides, in another aspect, a battery-powered portable cooler including a main body including a tub configured to receive contents, a cooling compartment, and insulation at least partly surrounding the tub. The battery-powered portable cooler includes a lid that opens and closes to selectively provide access to the tub, a wheel supporting the main body on a support surface, a user interface, and a refrigeration system including: a compressor located in the cooling compartment, a condenser located in the cooling compartment, an expansion valve located in the cooling compartment, and an evaporator including evaporator coils at least partly surrounding the tub to conductively cool the contents of the tub. The battery-powered portable cooler includes an electronic control unit operably connected to the user interface. The electronic control unit receives input from the user interface and controls operation of the refrigeration system. The battery-powered portable cooler includes a battery receptacle and a battery pack for mating with the battery receptacle. The battery pack provides electrical power to the electronic control unit, the user interface, and the refrigeration system. The battery-powered portable cooler includes a mister located within the tub. The mister includes a suction hose, a water pump, and a misting nozzle. The mister draws water from a bottom of the tub and sprays a water mist into the tub to increase a surface area of the contents in contact with the water.

The present invention provides, in another aspect, a battery-powered portable cooler including a main body including a tub for receiving contents, a cooling compartment, and insulation at least partly surrounding the tub; a lid that opens and closes to selectively provide access to the tub; a wheel supporting the main body on a support surface; a user interface; and a refrigeration system including a compressor located in the cooling compartment, a condenser located in the cooling compartment, an expansion valve located in the cooling compartment, and an evaporator including evaporator coils at least partly surrounding the tub to conductively cool the contents of the tub. The battery-powered portable cooler includes an electronic control unit operably connected to the user interface, a battery receptacle, and a battery pack for mating with the battery receptacle. The electronic control unit receives input from the user interface and controls operation of the refrigeration system. The battery pack provides electrical power to the electronic control unit, the user interface, and the refrigeration system. The electronic control unit operates the refrigeration system in a first mode in which the refrigeration system attempts to reach a first target air temperature within the tub and, when the first target air temperature is reached, regulates an actual air temperature within the tub to target the first target air temperature via closed loop feedback. The electronic control unit operates the refrigeration system in a second mode in which the refrigeration system initially attempts to reach a second target air temperature within the tub and subsequently regulates the actual air temperature within the tub to target the first target air temperature via closed loop feedback. The second target air temperature is less than the first target air temperature.

The present invention provides, in another aspect, a battery-powered portable cooler comprising a main body including a tub configured to receive contents, a cooling compartment, and insulation at least partly surrounding the tub; a lid configured to open and close to selectively provide access to the tub; a wheel supporting the main body on a support surface; a user interface; and a refrigeration system including: a compressor located in the cooling compartment, a condenser located in the cooling compartment, an expansion valve located in the cooling compartment, and an evaporator including evaporator coils at least partly surrounding the tub to conductively cool the contents of the tub. The battery-powered portable cooler includes an electronic control unit operably connected to the user interface. The electronic control unit receives input from the user interface and controls operation of the refrigeration system. The battery-powered portable cooler includes a battery receptacle and a battery pack for mating with the battery receptacle. The battery pack provides electrical power to the electronic control unit, the user interface, and the refrigeration system. The battery-powered portable cooler includes a DC power input cable configured to receive electrical current from a remote DC source other than the battery receptacle. The electronic control unit senses an input voltage received through the DC power input cable and determines an operation state of the battery-powered portable cooler based on the input voltage. The operation state of the battery-powered portable cooler is selected from a first operation state in which the battery-powered portable cooler is “on” and the refrigeration system is activated, a second operation state in which the battery-powered portable cooler is “on” and the refrigeration system is deactivated, and a third operation state in which the battery-powered portable cooler is “off.”

Other features and aspects of the invention will become apparent by consideration of the following detailed description and accompanying drawings.

### BRIEF DESCRIPTION OF THE DRAWINGS

FIG. 1 is a perspective view of a portable cooler in accordance with an embodiment of the invention.

FIG. 2 is a side view of a user interface of the portable cooler of FIG. 1.

FIG. 3 is a perspective view of the portable cooler of FIG. 1.

FIG. 4 is a side view of the portable cooler of FIG. 1.

FIG. 5 is a front view of the portable cooler of FIG. 1.

FIG. 6 is another side view of the portable cooler of FIG. 1.

FIG. 7 is a rear view of the portable cooler of FIG. 1.

FIG. 8 is a bottom view of the portable cooler of FIG. 1.

FIG. 9 is a top view of the portable cooler of FIG. 1.

FIG. 10 is a partial cutaway view of the portable cooler of FIG. 1.

FIG. 11 is a cross-sectional view of the portable cooler of FIG. 1 along section line 11-11 in FIG. 9.

FIG. 12 is a perspective cross-sectional view of the portable cooler of FIG. 1 along section line 12-12 in FIG. 9.

FIG. 13 is a schematic view of a mister within a cooler tub of the portable cooler of FIG. 1.

FIG. 14 is a graph illustrating different operational modes of the portable cooler of FIG. 1.

FIG. 15 is schematic view of a decision-making framework with which an electronic control unit of the portable cooler of FIG. 1 chooses between operation states based upon a sensed input voltage.

FIG. 16 is a perspective view of the portable cooler of FIG. 1 showing tie-down hooks and tie-downs.

FIG. 17 is a perspective view of a tie-down hook of FIG. 16.

FIG. 18 is a schematic view of an angled bottom of the cooler tub of the portable cooler of FIG. 1.

FIG. 19 is a perspective view of the cooler tub of the portable cooler of FIG. 1 including a divider slot.

FIG. 20 is a perspective view of the portable cooler of FIG. 1 including a cable wrap mount.

FIG. 21 is a perspective view of the portable cooler of FIG. 1 including a rear stand.

FIG. 22 is a perspective view of the portable cooler of FIG. 1 including a bottle opener.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

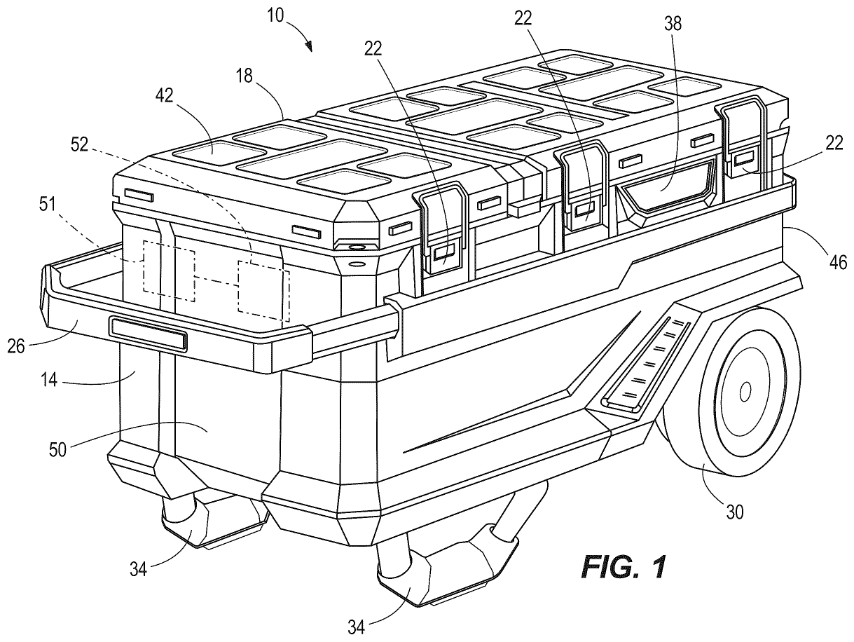

With reference to FIG. 1, a portable cooler 10 (e.g., a battery-powered portable cooler) includes a main body 14, a lid 18, lid latches 22, a handle 26, wheels 30, legs 34, and a user interface 38. The main body 14 and the lid 18 are insulated to inhibit a transfer of heat from an ambient environment into an interior cavity of the portable cooler 10. The lid 18 includes an arrangement of locking cleats 42 at a top side of the lid 18. The locking cleats 42 are engageable with mating cleats on another object (e.g., one or more power tool cases, toolboxes, organizers, and/or other storage containers) to enable the object to be connected to the top side of the lid 18 as further disclosed in U.S. Pat. Nos. 9,539,722; 10,086,508; and 11,267,119, the entire contents of all of which are incorporated herein by reference, and as further disclosed in U.S. Patent Application Publication No. 2020/0165036, the entire content of which is incorporated herein by reference. The lid 18 is pivotable relative to the main body 14 about a hinge between an open position and a closed position (shown in FIG. 1). In the closed position, the latches 22 releasably affix the lid 18 to the main body 14.

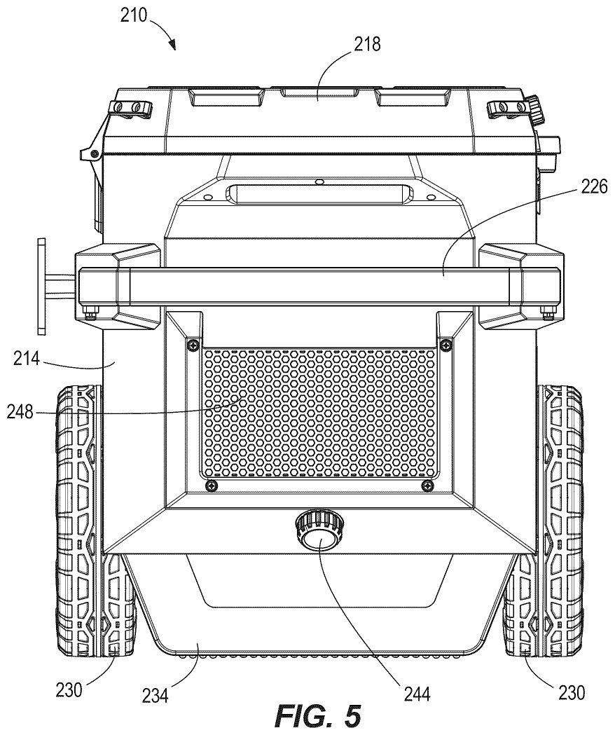

With continued reference to FIG. 1, two wheels 30 are positioned below the main body 14 at a rear side 46 of the main body 14 to support the main body 14 and enable the main body 14 to be rolled. In some embodiments, a single roller may be used in place of the wheels 30, or more than two wheels 30 may be provided. Two legs 34 are provided below the main body 14 at a front side 50 of the main body 14, which is opposite the rear side 46, to cooperate with the wheels 30 to support the main body 14 in a resting position in which the legs 34 as well as the wheels 30 rest on a support surface (e.g., a substantially flat support surface). In some embodiments, the portable cooler 10 may include a single leg 34 (for example, see the leg 234 of FIG. 5) or more than two legs 34. The legs 34 may include extruded metal with molded feet, and the legs 34 may be screwed onto a bottom of the main body 14.

With continued reference to FIG. 1, the handle 26 extends from the front side 50 of the main body 14 to enable a user to pivot the main body 14 about the wheels 30 so that the legs 34 are raised off the ground. The handle 26 is extendable and retractable so that a user may adjust the handle 26 to a comfortable length.

With continued reference to FIG. 1, the portable cooler 10 includes an onboard cooling system 51 to cool the interior cavity of the main body 14, such as the cooling system disclosed in U.S. patent application Ser. No. 18/668,391 filed on May 20, 2024, the entire content of which is incorporated herein by reference. The cooling system 51 may be powered by one or more portable power tool battery packs 52, by a remote AC power input, by a remote DC power input, or by a combination thereof. In some embodiments, the portable cooler 10 may include an onboard charger such that while the portable cooler 10 is plugged into a remote AC power input, the onboard charger will charge the one or more attached battery packs 52.

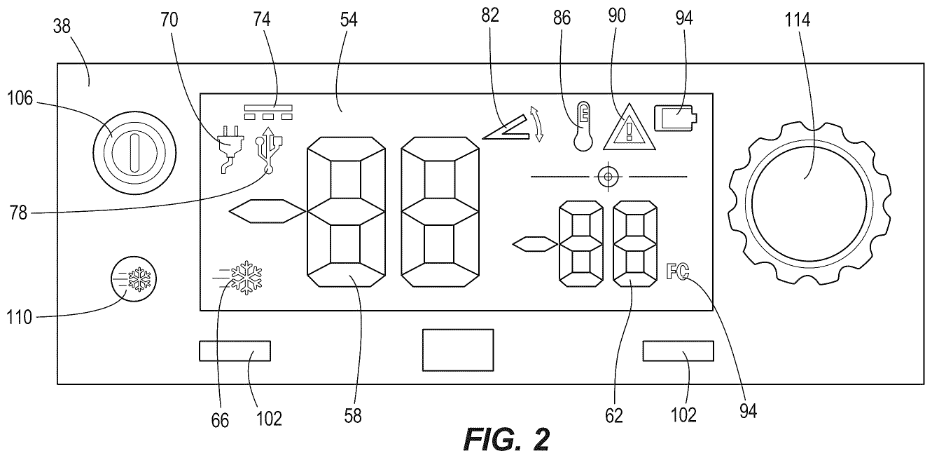

With reference to FIG. 2, the user interface 38 includes a display 54 that indicates a cooler temperature value 58 (i.e., the actual temperature in the interior cavity of the portable cooler 10), a target temperature value 62 (i.e., the temperature selected by a user as a desired temperature in the interior cavity of the portable cooler 10), a quick chill indicator light 66 (e.g., an indicator light to indicate that the user has instructed a controller such as an electronic control unit to operate the cooling system 51 of the portable cooler 10 under a quick chill or “Rapid Cool” protocol (in which a refrigeration system attempts to cool the contents of the portable cooler 10 more rapidly than is typical), or an indicator light to indicate that the controller is operating the cooling system 51 of the portable cooler 10 under the quick chill protocol, etc.), an AC power indicator light 70 (e.g., to display that the portable cooler 10 is attached to a remote AC power input), a DC power indicator light 74 (e.g., to display that the portable cooler 10 is attached to a remote DC power input), a USB indicator light 78 (e.g., to indicate that power is supplied to a USB port of the portable cooler 10, or to indicate that a power consumer is attached to a USB port of the portable cooler 10, etc.), an angle alert indicator light 82 (e.g., to indicate that the portable cooler 10 is tilted beyond a predetermined angular threshold such as 10 degrees, 15 degrees, 20 degrees, 25 degrees, 30 degrees, 35 degrees, etc.), a unit over-temperature indicator light 86 (e.g., to indicate that the cooling system 51, the battery pack 52, the controller of the portable cooler 10, or another component of the portable cooler 10 has exceeded a threshold temperature), an electronics overload indicator light 90 (e.g., to indicate an over-current state of the controller or other electronics, to indicate an over-voltage state of the controller or other electronics, or to indicate another improper state of the controller or other electronics), a low battery indicator light 94 (e.g., to indicate a state of charge of the battery pack 52 that is below a threshold), and a unit indicator light 98 (e.g., to indicate which temperature measurement unit is being used, in degrees Fahrenheit or Celsius, with the cooler temperature value 58 and the target temperature value 62).

With continued reference to FIG. 2, the user interface 38 includes battery pack state of charge indicators 102 that indicate a state of charge of the battery pack 52 during charging (for example, while being charged by the onboard charger and the remote AC power input). The user interface 38 includes a power on/off selector 106 to control whether the user interface 38 and/or the cooling system 51 is powered, a quick chill selector 110 for use by a user to control whether the cooling system 51 is operated under a quick chill protocol, and a temperature selector 114 (e.g., a temperature dial) for a user to select the target temperature. In some embodiments, if the temperature selector 114 is adjusted by a user and is subsequently allowed to remain in one position for more than a threshold amount of time (e.g., five seconds), the controller adopts the selected temperature as the target temperature. Alternatively, a user may press the temperature selector 114 to instruct the controller to adopt the selected temperature as the target temperature. To change the displayed temperature units, a user may press and hold the temperature selector 114 for three seconds, subsequently rotate the temperature selector 114 to choose between units (e.g., Fahrenheit and Celsius units), and allow the temperature selector 114 to remain in that position for more than a threshold amount of time (e.g., five seconds). Alternatively, a user may press the temperature selector 114 to adopt the selected unit.

With continued reference to FIG. 2, an actuator (e.g., a button) on the portable cooler 10 may control whether power is delivered to a USB port on the portable cooler 10 and, accordingly, whether the USB indicator light 78 is in an “on” state. When the angle alert indicator light 82 is in an “on” state because the portable cooler 10 has been tilted beyond a predetermined angular threshold, an alarm may sound for a length of time (e.g., 0.5 seconds, 1 second, 1.5 seconds, 2 seconds, etc.), and the portable cooler 10 may power off. The portable cooler 10 may be power cycled to return to an “on” state. When the unit over-temperature indicator light 86 is in an “on” state, the portable cooler 10 may stop functioning and/or turn to an “off” state. When the temperature returns to a normal range, the portable cooler 10 may automatically resume operation, or the portable cooler 10 may be power-cycled to resume operation. When the electronics overload indicator light 90 is in an “on” state, the portable cooler 10 may stop functioning and/or turn to an “off” state. When the electronics return to normal operation, the portable cooler 10 may automatically resume operation, or the portable cooler 10 may be power-cycled to resume operation.

In operation, while plugged into a remote AC power input, the cooler 10 will default to operation under AC power, and the user interface 38 will indicate “ON.” The cooler 10 may charge one or more batteries (e.g., 18-volt power tool battery packs 52) while plugged into AC power. The cooler 10 may be fully operative while plugged into AC power and may be powered by AC power with or without any battery packs 52.

In operation, while plugged into a remote DC power input, the cooler 10 will default to operation under DC power, and the user interface 38 will indicate “ON.” The cooler 10 may not charge one or more battery packs 52 while plugged into DC power. The cooler 10 may otherwise be fully operative while plugged into DC power and may be powered by DC power with or without any battery packs 52.

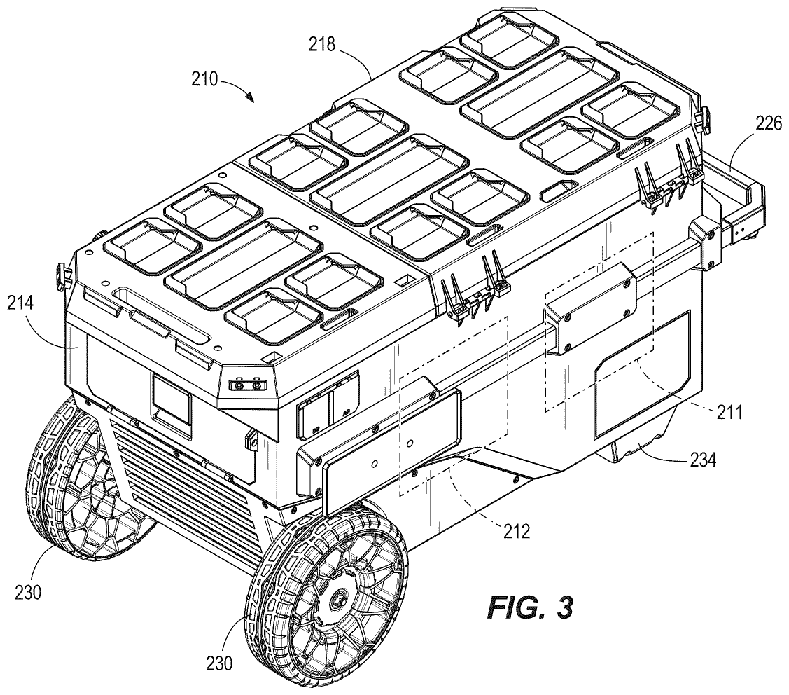

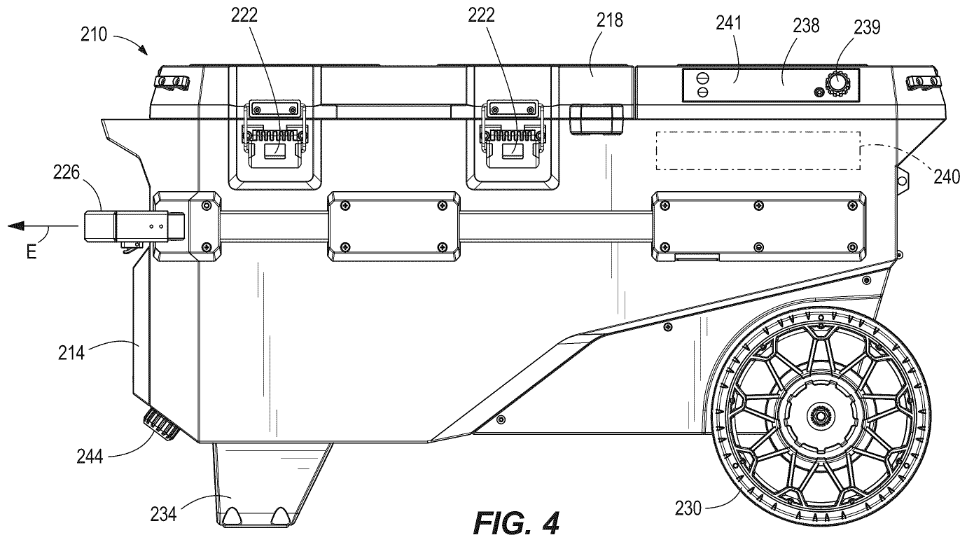

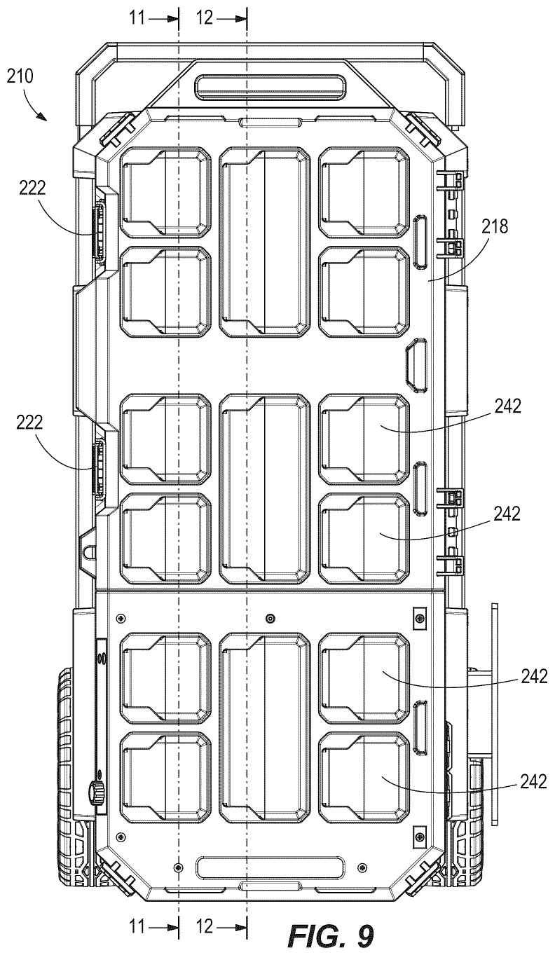

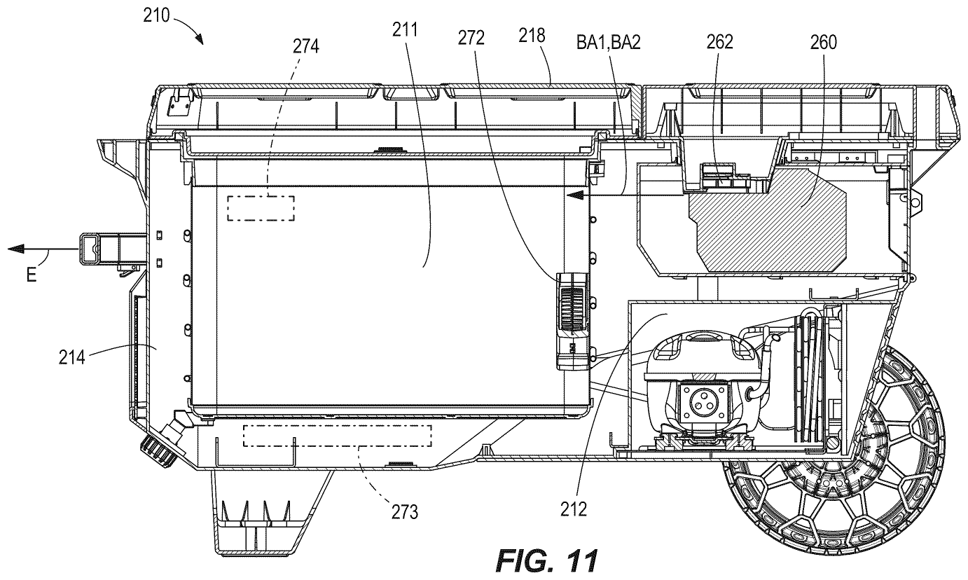

With reference to FIG. 3, a variation of the portable cooler 10 may include a portable cooler 210 (e.g., a battery-powered portable cooler 210). As the portable cooler 210 merely illustrates certain variations of the portable cooler 10, the features described herein with reference to the portable cooler 10 may apply to the portable cooler 210 and vice versa. The battery-powered portable cooler 210 may include a main body 214, a lid 218, lid latches 222, an extendable handle 226, wheels 230, and a leg 234 opposite the wheels 230. The wheels may have a diameter of, for example, 8 inches, 9 inches, or 10 inches. The wheels 230 may include a polypropylene hub with thermoplastic elastomer tread. The handle 226 is extendable in an extension direction E (FIG. 4). One or more detents may retain the handle 226 in one or more positions corresponding to various extension lengths such as, for example, a fully extended length. The handle 226 may include a button that may be pressed by a user to disengage the detent to allow the handle 226 to be retracted. The handle 226 may include a plastic molded portion surrounding an extruded metal portion. The portable cooler 210 includes a user interface 238 (FIG. 4) with which a user communicates with a controller 240 (e.g., an electronic control unit 240) and/or with which the controller 240 communicates with the user. The user interface 238 may in some embodiments be the user interface 38 or may be a variation of the user interface 38. The user interfaces 38, 238 may include a transreflective segmented liquid crystal display (“LCD”) that may be backlit in low-light conditions. The lid 218 includes an arrangement of locking cleats 242 on a top side of the lid 218 (FIG. 9). The locking cleats 242 are engageable with mating cleats on another object (e.g., one or more power tool cases, toolboxes, organizers, and/or other storage containers) to enable the object to be connected to the top side of the lid 218 as otherwise described herein. The portable cooler 210 includes a cooler tub 211 and a cooling compartment 212 (shown schematically in FIG. 1 and also shown, for example, in FIGS. 11 and 12).

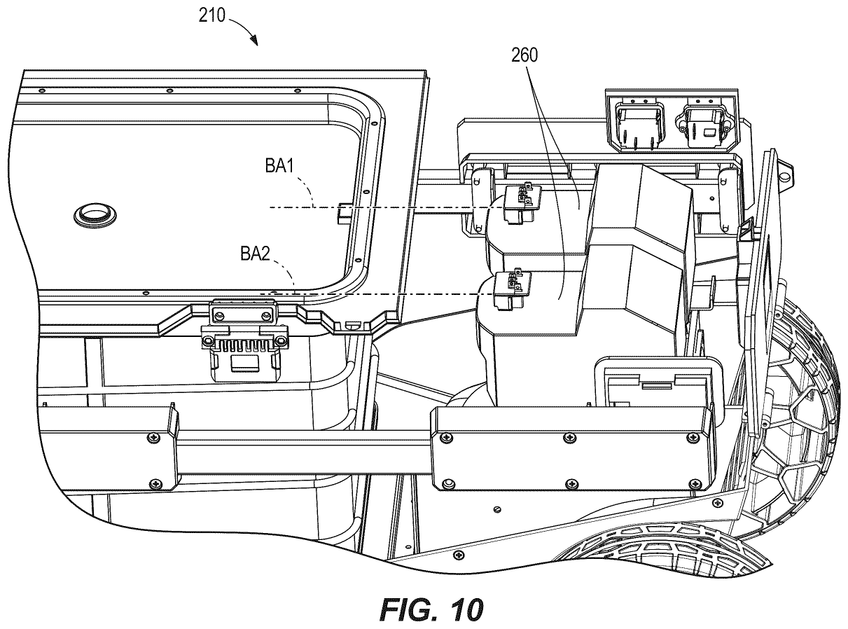

With reference to FIG. 4, the user interface 238 is positioned on a same side of the portable cooler 210 as the latches 222. The user interface 238 may include input actuators such as buttons or dials 239 to receive information and/or instructions from a user. The user interface 238 may include a display 241 configured to display information to the user. Information displayed by the display 241 may include a characteristic of the portable cooler 210 such as, for example, an actual air temperature within the cooler tub 211, a target air temperature within the cooler tub 211, a water level within the cooler tub 211, and/or a state of charge of one or more battery packs 260 (FIG. 10). A drain plug 244 is positioned at a front of the portable cooler 210 (i.e., on a shorter side of the portable cooler 210) to facilitate draining liquid from the portable cooler 210. The drain plug 244 may instead or additionally be positioned on any other side of the portable cooler 210 (e.g., on a longer side of the portable cooler 210). The drain plug 244 may be an internal drain plug 244 that seals the cooler tub 211 from leaking from within the cooler tub 211 or an external drain plug 244 that seals the cooler tub 211 from leaking from outside the cooler tub 211.

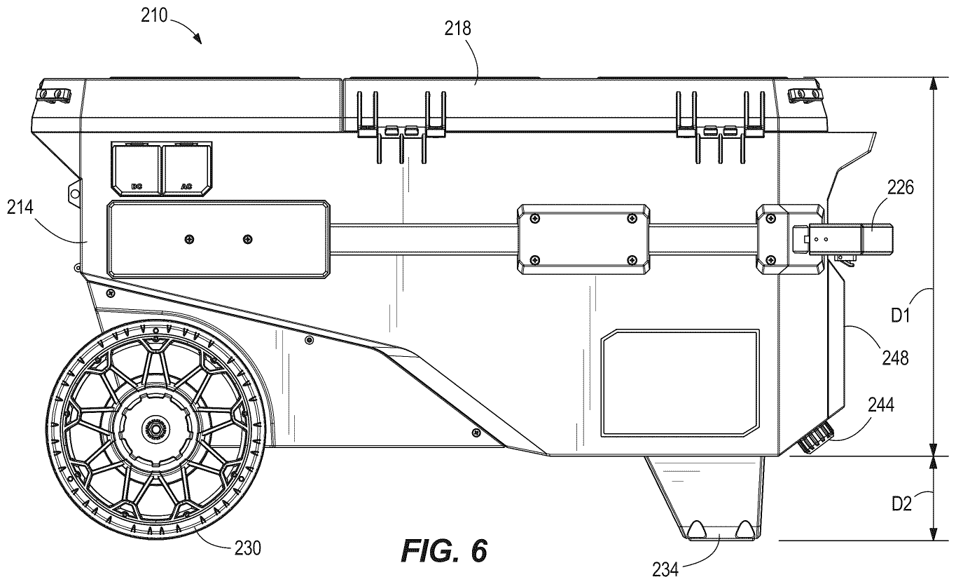

With reference to FIGS. 5 and 6, the portable cooler 210 includes a storage pouch 248. The storage pouch 248 may include an elastic webbing and may be positioned between the drain plug 244 and the extendable handle 226. A first distance D1 may extend vertically between a top of the cooler 210 and a top of the leg 234. A second distance D2 may extend vertically parallel to the distance D1 between a top of the leg 234 and a bottom of the leg 234. The first distance D1 may be 16 inches, approximately 16 inches, between 10 inches and 22 inches, etc. The second distance D2 may be 4 inches, approximately 4 inches, between 2 inches and 6 inches, etc.

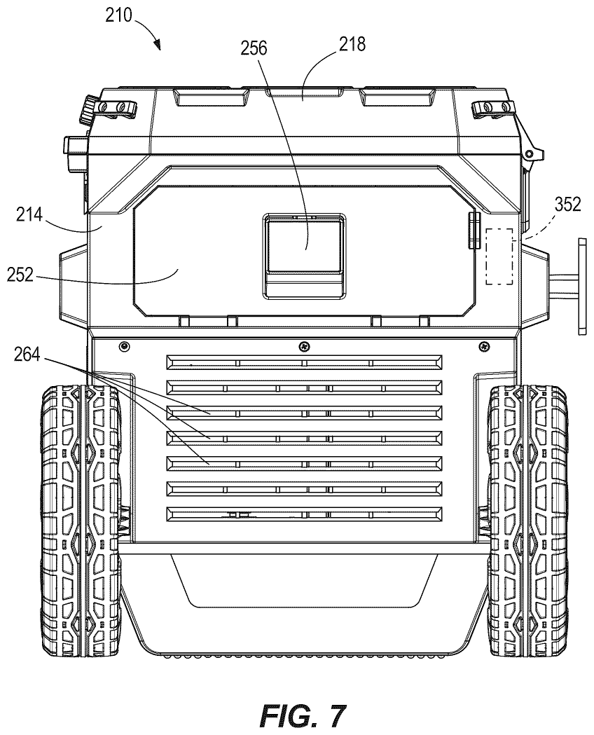

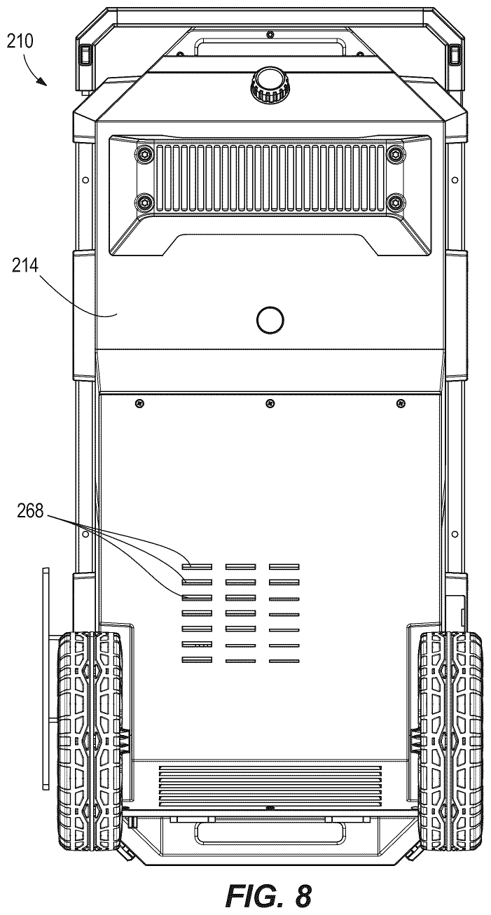

With reference to FIGS. 7, 8, and 10, the portable cooler 210 includes a battery compartment access door 252 including an actuator or handle 256. The battery compartment access door 252 may be sized and shaped so that one, two, or more battery packs 260 (FIG. 10) may pass through the door 252 for attachment to one or more battery receptacles 262 along a battery insertion axis BA1, BA2 (FIGS. 10 and 11). The battery insertion axes BA1, BA2 may be parallel. The battery insertion axis BA1, BA2 of each respective battery pack 260 may be oriented toward the cooler tub 211 (i.e., intersecting the cooler tub 211). The battery insertion axis BA1, BA2 of each respective battery pack 260 may be parallel to an extension direction E of the handle 226. The battery insertion axis BA1, BA2 of each respective battery pack 260 may not intersect the compressor 280. The battery insertion axis BA1, BA2 of each respective battery pack may not intersect the cooling compartment 212. The portable cooler 210 includes rear air vents 264 positioned on a rear of the portable cooler 210 to facilitate airflow through the cooling compartment 212. The portable cooler 210 includes lower air vents 268 positioned at a bottom side of the portable cooler 210 to facilitate airflow through the cooling compartment 212.

With reference to FIG. 11, the cooler tub 211 may include a fan 272 located within the cooler tub 211. The fan 272 may be controlled by the controller 240. For example, the fan 272 may be manually operated by a user through inputs to the user interface 238 or automatically by the controller 240 to generate a forced convection condition within the cooler tub 211. The fan 272 may be positioned on an inner sidewall of the cooler tub 211 that is closest to the cooling compartment 212.

With continued reference to FIG. 11, a load sensor 273 detects a load (e.g., a thermal mass or an estimate of a thermal mass) within the cooler tub 211. For example, the load sensor 273 may be a scale that weighs the contents of the cooler tub 211 to generate an estimate of the thermal mass of the contents. In some embodiments, the load sensor 273 may include a laser sensor or may include a plurality of laser sensors to detect a volume occupied by the contents of the cooler tub 211 to generate an estimate of the thermal mass of the contents. The controller 240 may determine a duty cycle, a target temperature, or another characteristic of the portable cooler 210 based at least in part on an input from the load sensor 273. The portable cooler 210 may include one or more lights 274 for illuminating an interior of the cooler tub 211. The light 274 may be positioned within the cooler tub 211.

With reference to FIG. 12, the portable cooler 210 includes a refrigeration system 276 including a compressor 280 located in the cooling compartment 212, a condenser 284 located in the cooling compartment 212, an expansion valve 288 located in the cooling compartment 212, and an evaporator 292 including evaporator coils 296 at least partly surrounding the cooler tub 211. The evaporator coils 296 may completely encircle four sides of the cooler tub 211. When the refrigeration system 276 is in operation, the evaporator coils 296 remove heat from an interior of the cooler tub 211 to cool contents 298 of the cooler tub 211, and the refrigeration system 276 releases the heat in the cooling compartment 212 at the condenser 284. The evaporator coils 296 remove heat from the contents of the cooler tub 211 via conductive cooling. The controller 240 controls one or more aspects of the operation of the refrigeration system 276, including, for example, a target air temperature within the cooler tub 211. In operation, the compressor 280 pressurizes the refrigerant causing increased temperature. The condenser 284 takes the high temperature, high pressure refrigerant and releases its heat to the outside air, cooled by free and/or forced convection, and the condenser 284 turns the refrigerant to a subcooled liquid. The expansion valve 288 reduces the pressure and temperature of the refrigerant as the refrigerant passes through the expansion valve 288, allowing the refrigerant to turn into a cool, low-pressure liquid. The refrigerant then passes to the evaporator 292, in which the refrigerant absorbs heat from the contents of the cooler 10.

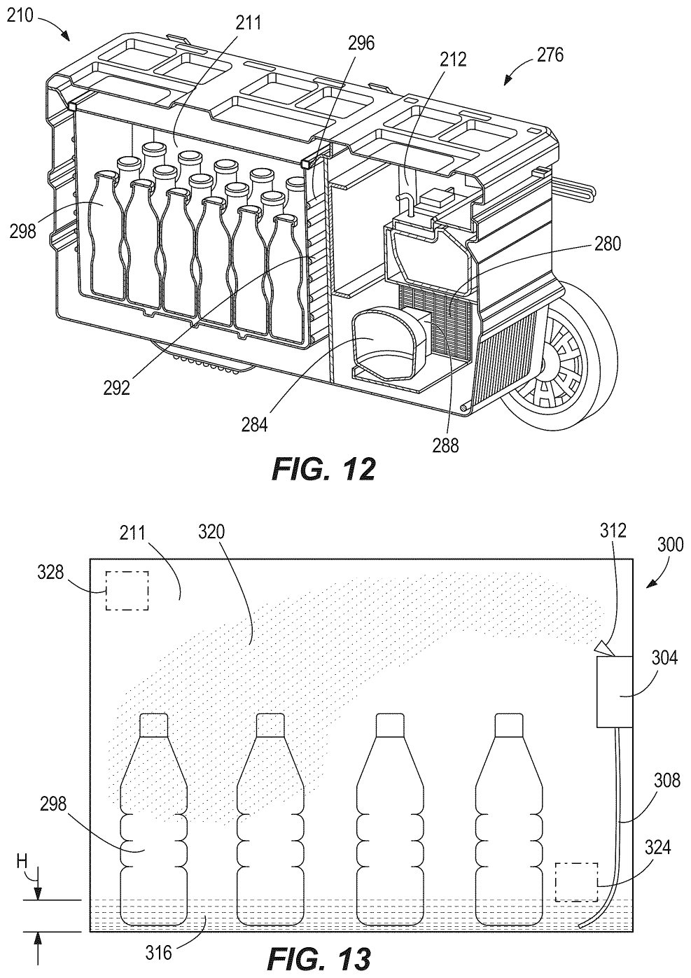

With reference to FIG. 13, the cooler tub 211 may include a mister 300. The mister 300 includes a water pump 304, a suction (or pick-up) hose 308, and a misting nozzle 312. In operation, the water pump 304 draws water 316 from a bottom of the cooler tub 211 through the suction hose 308. The water pump 304 forces the water 316 through the misting nozzle 312 to form a fine mist 320, which is sprayed within the cooler tub 211 to increase a surface area of contact between the water 316 and the contents 298 of the cooler tub 211. The portable cooler 210 may include a water level sensor 324 to determine a water level (or height) H within the cooler tub 211. The water level sensor 324 may be operably coupled for communication to the controller 240. The controller 240 may place the mister 300 in an “off” state if an input from the water level sensor 324 indicates that the water level H within the cooler tub 211 is less than a minimum threshold water level. The controller 240 may automatically place the mister 300 in an “on” state if an input from the water level sensor 324 indicates that the water level H within the cooler tub 211 is greater than the minimum threshold water level. The controller 240 may operate the mister 300 differently depending on a temperature difference between a target air temperature within the cooler tub 211 and an actual air temperature within the cooler tub 211. For example, the controller 240 may place the mister 300 in the “on” state if a temperature difference between the target air temperature and the actual air temperature is greater than a minimum threshold and may place the mister 300 in the “off” state if the temperature difference falls below the minimum threshold. The portable cooler 210 may include an angle sensor 328 to determine an angle of the portable cooler 210 (and/or an angle of the water 316 within the cooler tub 211) from horizontal based upon the frame of reference of FIG. 11. The angle sensor 328 may be operably coupled for communication to the controller 240. The controller 240 may place the mister 300 in an “off” state if an input from the angle sensor 328 indicates that the angle of the portable cooler 210 from horizontal (and/or the angle of the water 316 within the cooler tub 211 from horizontal) exceeds a threshold maximum angle (e.g., 15 degrees, 30 degrees, 45 degrees, etc.). The controller 240 may automatically place the mister 300 in an “on” state if an input from the angle sensor 328 indicates that the angle of the portable cooler 210 (and/or the angle of the water 316 within the cooler tub 211) from horizontal is below the threshold maximum angle. In some embodiments, the mister 300 may be controllable by a user through user inputs made to the user interface 238.

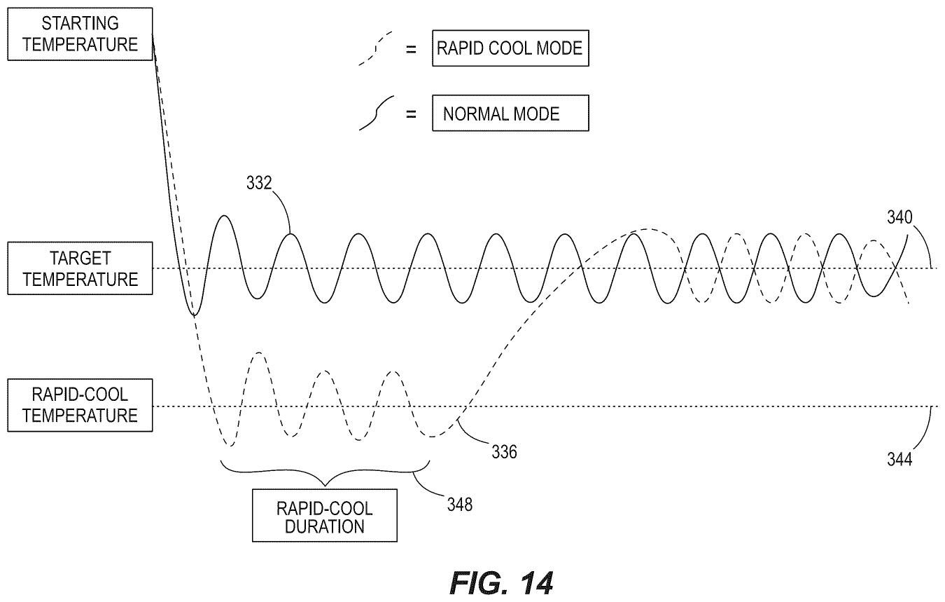

With reference to FIG. 14, the controller 240 may be configured to control the refrigeration system 276 and to operate the refrigeration system 276 in a first “Normal” mode 332 and a second “Rapid Cool” mode 336. FIG. 14 schematically illustrates temperatures on the vertical axis with the starting temperature in the upper left-hand corner. Time is illustrated on the horizontal axis, with time progressing toward the right as the refrigeration system 276 operates. In the first mode 332, the controller 240 operates the refrigeration system 276 to attempt to reduce the actual air temperature to reach a first target air temperature 340 within the cooler tub 211. When the first target air temperature 340 is reached within the cooler tub 211, the refrigeration system 276 regulates an actual air temperature within the cooler tub 211 to target the first target temperature 340. Targeting a target temperature (i.e., a setpoint) such as the first target temperature includes utilizing a closed loop system to receive actual temperature data from the cooler tub 211 and modify the amount of refrigeration that is applied to the cooler tub 211 to achieve the target temperature such as the first target temperature (i.e., closed loop feedback). A target temperature may include an allowable temperature range such that the actual temperature, in some situations, oscillates around the target temperature as shown in FIG. 14. In the second mode 336, the controller 240 operates the refrigeration system 276 to initially attempt to reduce the actual air temperature to reach a second target air temperature 344 within the cooler tub 211 during the second mode duration 348 (or “Rapid Cool duration” 348). The second target air temperature 344 is less than the first target air temperature 340. Subsequent to the second mode duration 348 in which the refrigeration system 276 initially attempts to reduce the actual air temperature to reach the second target air temperature 344, the controller 240 operates the refrigeration system 276 to regulate the actual air temperature within the cooler tub 211 to target the first target air temperature 340. In some embodiments, a temperature difference between the first target air temperature 340 and the second target air temperature 344 may be a predetermined constant such as, for example, 5 degrees Fahrenheit, 10 degrees Fahrenheit, 15 degrees Fahrenheit, etc.

With continued reference to FIG. 14, in some embodiments, the controller 240 may operate the refrigeration system 276 such that, in the second mode, the refrigeration system 276 attempts to reach the second target air temperature 344 and, when the second target air temperature is reached, regulates the actual air temperature within the cooler tub 211 to target the first target air temperature 340.

With continued reference to FIG. 14, in some embodiments, the controller 240 may operate the refrigeration system 276 such that, in the second mode, the refrigeration system 276 attempts to reach the second target air temperature 344 for a period of time (such as the “Rapid Cool duration” 348) and, upon expiration of the period of time, regulates the actual air temperature within the cooler tub 211 to target the first target air temperature 340. In some embodiments, the period of time may be a predetermined period of time. In some embodiments, the predetermined period of time may be, for example, 5 minutes, 10 minutes, 15 minutes, 20 minutes, 25 minutes, 30 minutes, 35 minutes, 40 minutes, 45 minutes, 50 minutes, 55 minutes, 60 minutes, etc. In some embodiments, the period of time may be determined by the controller 240 based on at least one of a parameter available to the controller such as, for example, a state of charge of the battery pack 260 (e.g., the controller 240 may choose a smaller period of time if the state of charge of the battery pack 260 is less than a minimum threshold), a measured or calculated rate of cooling, or an ambient temperature (e.g., the controller 240 may choose a larger period of time if the ambient temperature is above a threshold temperature). In some embodiments, the controller 240 may operate the fan 272 (i.e., place the fan 272 in an “on” state) when the controller 240 is in the second “Rapid Cool” mode 336.

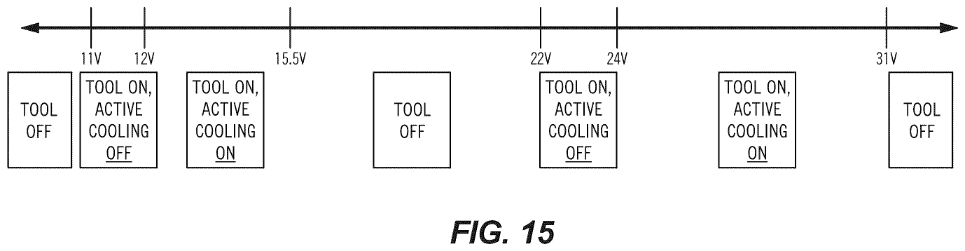

The portable cooler 210 may include an alternative DC power input cable 352 (shown schematically in FIG. 7). The DC power input cable 352 selectively receives electrical current from a DC source other than the battery receptacle 262. For example, the DC power input cable 352 may include a DC power input plug that is shaped and sized to mate with a DC plug in a vehicle (e.g., a cigarette lighter) and receive electrical current from the vehicle's electrical system (e.g., a nominal 12-volt electrical system or a nominal 24-volt electrical system). With reference to FIG. 15, the controller 240 may be configured to sense an input voltage on the DC power input cable 352 (e.g., via a voltage sensor). Based on the input voltage on the DC power input cable 352, the controller 240 may determine, based on the input voltage, an operation state of the portable cooler 210. For example, the controller 240 may determine based on the input voltage to the DC power input cable 352 that the portable cooler 210 will operate in a first operation state in which the portable cooler 210 is “on” and the refrigeration system 276 is actively cooling the cooler tub 211 (i.e., the refrigeration system 276 is activated), a second operation state in which the portable cooler 210 is “on” and the refrigeration system 276 is not actively cooling the cooler tub 211 (i.e., the refrigeration system 276 is deactivated), or a third operation state in which the portable cooler 210 is “off.” For example, the controller 240 may select the first operation state when the sensed input voltage is between 12 volts and 15.5 volts or between 24 volts and 31 volts; the controller 240 may select the second operation state when the sensed input voltage is between 11 volts and 12 volts or between 22 volts and 24 volts; and the controller 240 may select the third operation state when the sensed input voltage is less than 11 volts, between 15.5 volts and 22 volts, or greater than 31 volts. In some embodiments, the controller 240 may place the mister 300 in an “on” state when in the first operation state and may place the mister 300 in an “off” state when in the second operation state. In some embodiments, the controller 240 may place the fan 272 in an “on” state when in the first operation state and may place the fan 272 in an “off” state when in the second operation state.

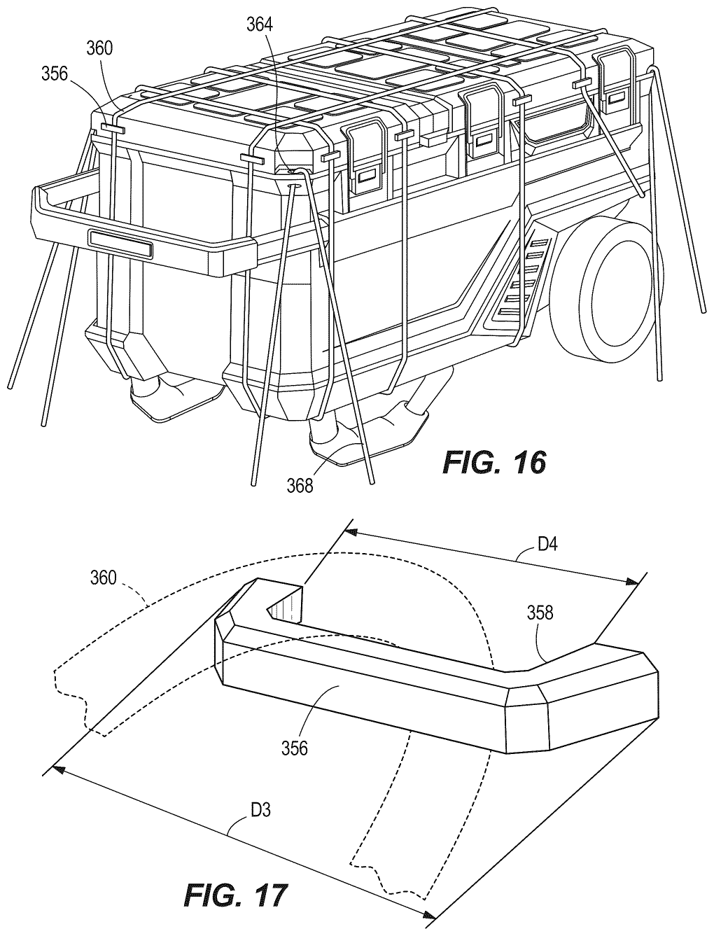

With reference to FIGS. 16 and 17, the portable cooler 10, 210 may include first tie-down hooks 356 for passing first tie-downs such as first ropes 360 through the first tie-down hooks 356 to strap the portable cooler 10, 210 to another object. The portable cooler 10, 210 may include second tie-down hooks 364 for passing second tie-downs such as second ropes 368 through the second tie-down hooks 364 to strap the portable cooler 10, 210 to another object. The first tie-down hooks 356 include soft corners 358 to allow the first tie-down hooks 356 to flex and accommodate pressure as the first ropes 360 are tightened. The first and second tie-down hooks 356, 364 may be screwed into a component such as the lid 18, 218 or molded into a component such as the main body 14, 214 or the handle 26, 226. The first tie-down hooks 356 may include an outer width D3 of, for example, between 0.5 inches and 2.0 inches, between 0.75 inches and 1.5 inches, etc. and an inner width D4 of, for example, between 0.5 inches and 0.625 inches, between 0.375 inches and 0.75 inches, etc.

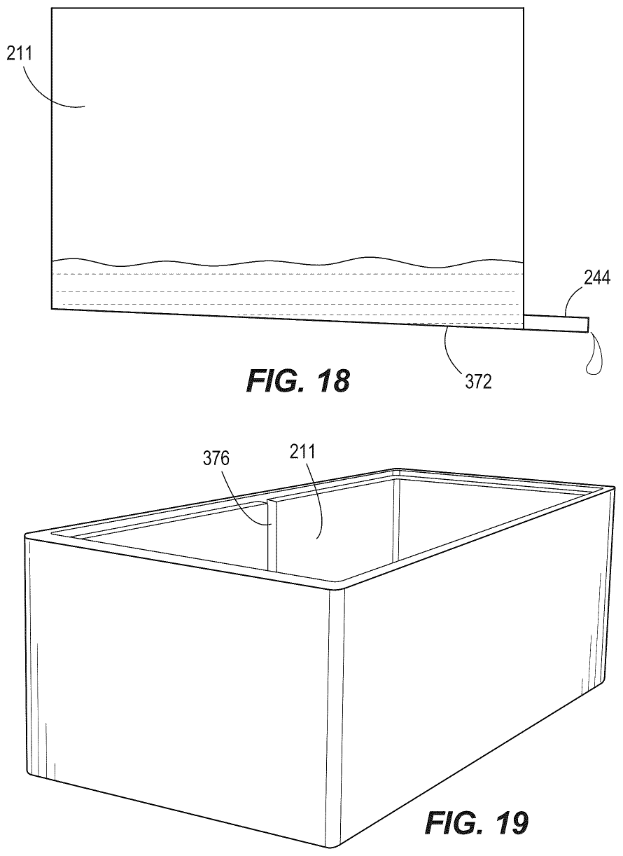

As shown schematically in FIG. 18, the portable cooler 10, 210 may include a bottom 372 of the cooler tub 211 that is sloped at an angle toward a drain hole or drain plug such as the drain plug 244. A portion of the bottom 372 may be sloped toward the drain plug 244, or the entirety of the bottom 372 may be sloped toward the drain plug 244.

With reference to FIG. 19, the cooler tub 211 may include one or more internal divider slots 376 for placement of dividers within the cooler tub 211 to divide the cooler tub 211 into two or more compartments. The internal divider slots 376 may be 8 mm wide, between 6 mm and 10 mm wide, etc.

The lids 18, 218 may include a soft-close mechanism (e.g., a hydraulic, electrical, or mechanical device or another type of device) to inhibit “slamming” of the lid 18, 218 by allowing the lid 18, 218 to gently close on its own when pushed toward the “closed” direction.

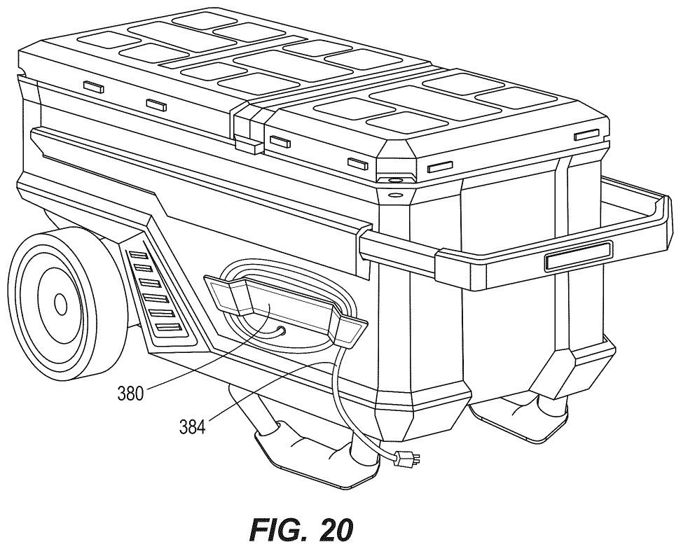

With reference to FIG. 20, the portable cooler 10, 210 may include a cable wrap mount 380 for wrapping a cable 384 and securing the cable 384 to a side of the portable cooler 10, 210.

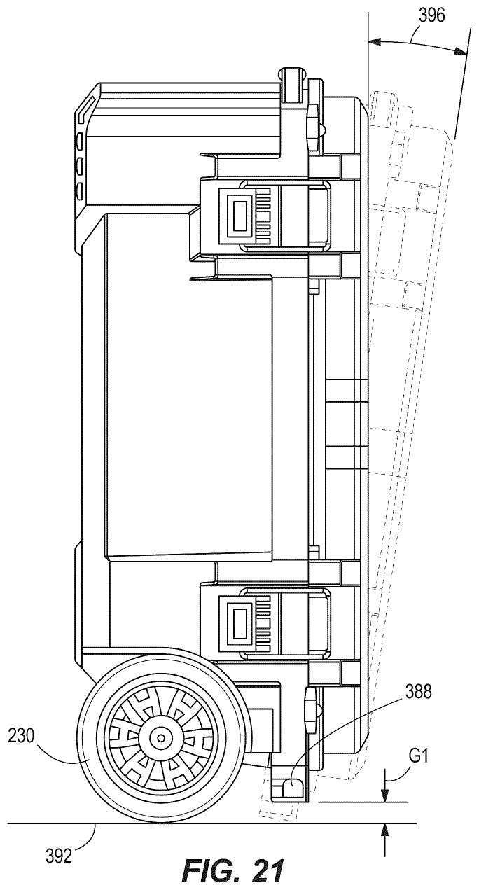

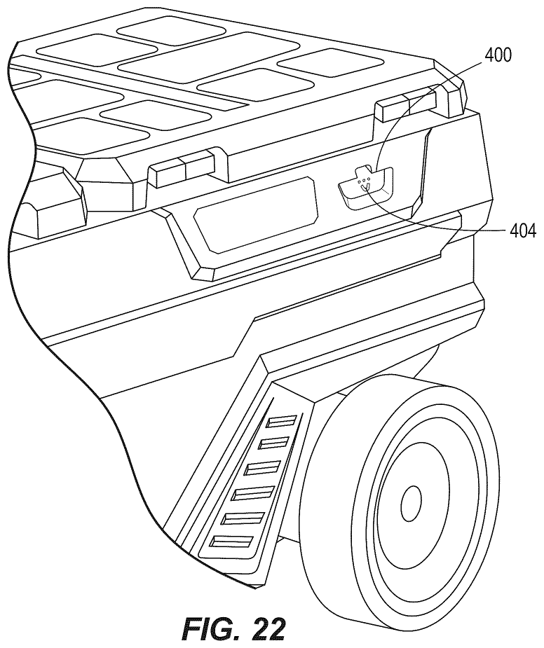

With reference to FIG. 21, the portable cooler 10, 210 is configured to dissuade a user from storing the portable cooler 10, 210 in an upright position as shown in FIG. 21. Discouraging a user from storing the portable cooler 10, 210 in an upright position may be desirable to inhibit potential damage caused to refrigeration components such as the compressor 280. The main body 14, 214 of the portable cooler 10, 210 may include a rearmost projection 388. However, in some embodiments, the rearmost projection 388 may not project beyond an outer edge of the wheels 230. FIG. 21 shows that when the portable cooler 10, 210 is rotated upwards about the wheels 230 to achieve a vertical position, a gap G1 is present between the rearmost projection 388 and a support surface 392 (e.g., a substantially flat support surface). To rest the portable cooler 10, 210 against the rearmost projection 388, the portable cooler 10, 210 must be rotated about the wheels 230 past the vertical position by an angle 396 (e.g., 5 degrees, 10 degrees, 15 degrees, etc.) to a precarious position. Therefore, the gap G1 dissuades a user from attempting to rotate the portable cooler 10, 210 to a vertical or near-vertical position.

With reference to FIG. 22, the portable cooler 10, 210 may include a bottle opener 400 on an exterior side of the cooler 10, 210. The bottle opener 400 may include a magnet 404 (schematically illustrated in FIG. 22) at a lower side of the bottle opener 400 to catch a bottle cap when the bottle cap is separated from a bottle.

Although the invention has been described in detail with reference to certain preferred embodiments, variations and modifications exist within the scope and spirit of one or more independent aspects of the invention as described.

1. A battery-powered portable cooler comprising:
a main body including a tub configured to receive contents, a cooling compartment, and insulation at least partly surrounding the tub;
a lid configured to open and close to selectively provide access to the tub;
a wheel supporting the main body on a support surface;
a user interface;
a refrigeration system including:
a compressor located in the cooling compartment,
a condenser located in the cooling compartment,
an expansion valve located in the cooling compartment, and
an evaporator including evaporator coils at least partly surrounding the tub to conductively cool the contents of the tub;
an electronic control unit operably connected to the user interface, the electronic control unit configured to receive input from the user interface and control operation of the refrigeration system;
a battery receptacle; and
a battery pack configured to mate with the battery receptacle along a battery insertion axis in a direction toward the tub, the battery pack configured to provide electrical power to the electronic control unit, the user interface, and the refrigeration system.

2. The battery-powered portable cooler of claim 1, further comprising a handle that is extendable in an extension direction, wherein the battery insertion axis of the battery pack is parallel to the extension direction.

3. The battery-powered portable cooler of claim 1, wherein:
the battery pack is a first battery pack,
the battery receptacle is a first battery receptacle,
the battery insertion axis is a first battery insertion axis, and
a second battery pack mates with a second battery receptacle along a second battery insertion axis in a direction parallel to the first battery insertion axis.

4. The battery-powered portable cooler of claim 1, further comprising a leg configured to cooperate with the wheel to support the battery-powered portable cooler on a substantially flat support surface, wherein the compressor is positioned between the battery receptacle and the support surface when both the leg and the wheel are in contact with the support surface.

5. The battery-powered portable cooler of claim 1, wherein the battery pack mates with the battery receptacle within a battery compartment, and wherein an access door selectively provides access to the battery compartment.

6. The battery-powered portable cooler of claim 1, wherein the battery insertion axis does not intersect the compressor.

7. The battery-powered portable cooler of claim 1, wherein the battery insertion axis does not intersect the cooling compartment.

8. The battery-powered portable cooler of claim 1, further comprising a leg configured to cooperate with the wheel to support the battery-powered portable cooler on a substantially flat support surface, wherein the battery insertion axis is parallel to a substantially flat support surface when both the leg and the wheel are in contact with the support surface.

9. A battery-powered portable cooler comprising:
a main body including a tub configured to receive contents, a cooling compartment, and insulation at least partly surrounding the tub;
a lid configured to open and close to selectively provide access to the tub;
a wheel supporting the main body on a support surface;
a user interface;
a refrigeration system including:
a compressor located in the cooling compartment,
a condenser located in the cooling compartment,
an expansion valve located in the cooling compartment, and
an evaporator including evaporator coils at least partly surrounding the tub to conductively cool the contents of the tub;
an electronic control unit operably connected to the user interface, the electronic control unit configured to receive input from the user interface and control operation of the refrigeration system;
a battery receptacle;
a battery pack configured to mate with the battery receptacle, the battery pack configured to provide electrical power to the electronic control unit, the user interface, and the refrigeration system; and
a fan coupled to a sidewall of the tub, the fan controlled by the electronic control unit and operable to generate a cooling airflow by forced convection within the tub.

10. The battery-powered portable cooler of claim 9, wherein the lid includes an arrangement of locking cleats on a top side of the lid, the locking cleats being engageable with mating cleats on an object to enable the object to be connected to the top side of the lid.

11. The battery-powered portable cooler of claim 9, further comprising a mister located within the tub, wherein the mister includes a suction hose, a water pump, and a misting nozzle, and wherein the mister is configured to draw water from a bottom of the tub and spray a water mist into the tub to increase a surface area of the contents in contact with the water.

12. The battery-powered portable cooler of claim 9, further comprising a DC power input cable configured to receive electrical current from a remote DC source other than the battery receptacle, wherein the electronic control unit is configured to sense an input voltage received through the DC power input cable and determine, based on the input voltage, an operation state of the battery-powered portable cooler, wherein:
the operation state of the battery-powered portable cooler is selected from:
a first operation state in which the battery-powered portable cooler is “on,” the refrigeration system is activated, and the fan is “on,”
a second operation state in which the battery-powered portable cooler is “on,” the refrigeration system is deactivated, and the fan is “off,” and
a third operation state in which the battery-powered portable cooler is “off” and the fan is “off,”
the DC power input cable includes a DC power input plug configured to receive electrical current from a DC power supply in a vehicle at a nominal voltage of 12 volts or 24 volts,
the electronic control unit selects the first operation state when the sensed input voltage is between 12 volts and 15.5 volts or between 24 volts and 31 volts,
the electronic control unit selects the second operation state when the sensed input voltage is between 11 volts and 12 volts or between 22 volts and 24 volts, and
the electronic control unit selects the third operation state when the sensed input voltage is less than 11 volts, between 15.5 volts and 22 volts, or greater than 31 volts.

13. The battery-powered portable cooler of claim 9, wherein the fan is controllable by user inputs made to the user interface.

14. A battery-powered portable cooler comprising:
a main body including a tub configured to receive contents, a cooling compartment, and insulation at least partly surrounding the tub;
a lid configured to open and close to selectively provide access to the tub;
a wheel supporting the main body on a support surface;
a user interface;
a refrigeration system including:
a compressor located in the cooling compartment,
a condenser located in the cooling compartment,
an expansion valve located in the cooling compartment, and
an evaporator including evaporator coils at least partly surrounding the tub to conductively cool the contents of the tub;
an electronic control unit operably connected to the user interface, the electronic control unit configured to receive input from the user interface and control operation of the refrigeration system;
a battery receptacle;
a battery pack configured to mate with the battery receptacle, the battery pack configured to provide electrical power to the electronic control unit, the user interface, and the refrigeration system; and
a mister located within the tub, wherein the mister includes a suction hose, a water pump, and a misting nozzle, and wherein the mister is configured to draw water from a bottom of the tub and spray a water mist into the tub to increase a surface area of the contents in contact with the water.

15. The battery-powered portable cooler of claim 14, further comprising a water level sensor within the tub, the water level sensor operably coupled for communication to the electronic control unit, wherein the electronic control unit places the mister in an “off” state if an input from the water level sensor indicates that a water level within the tub is less than a minimum threshold water level.

16. The battery-powered portable cooler of claim 14, further comprising an angle sensor, the angle sensor operably coupled for communication to the electronic control unit, wherein the electronic control unit places the mister in an “off” state if an input from the angle sensor indicates that an angle of the battery-powered portable cooler exceeds a maximum threshold.

17. The battery-powered portable cooler of claim 14, wherein the mister is controllable by user inputs made to the user interface.

18. The battery-powered portable cooler of claim 14, wherein the electronic control unit is configured to:
operate the refrigeration system in a first mode in which the refrigeration system attempts to reach a first target air temperature within the tub and, when the first target air temperature is reached, regulates an actual air temperature within the tub to target the first target air temperature via closed loop feedback, and
operate the refrigeration system in a second mode in which the refrigeration system initially attempts to reach a second target air temperature within the tub, the second target air temperature being less than the first target air temperature, and subsequently regulates the actual air temperature within the tub to target the first target air temperature via closed loop feedback, wherein the electronic control unit operates the mister when the refrigeration system is in the second mode.

19. The battery-powered portable cooler of claim 18, wherein:
in the second mode, the refrigeration system attempts to reach the second target air temperature for a period of time and, upon expiration of the period of time, regulates the actual air temperature within the tub to target first target air temperature via closed loop feedback, and
the period of time is determined by the electronic control unit based on at least one of a state of charge of the battery pack, a measured or calculated rate of cooling, or an ambient temperature.

20. The battery-powered portable cooler of claim 14, wherein:
the battery pack is configured to mate with the battery receptacle along a first battery insertion axis in a first battery insertion axis direction toward the tub,
the battery pack is a first battery pack and the battery receptacle is a first battery receptacle, and
a second battery pack mates with a second battery receptacle along a second battery insertion axis in a second battery insertion axis direction parallel to the first battery insertion axis,
wherein neither the first battery insertion axis nor the second battery insertion axis intersects the cooling compartment.

21.-30. (canceled)
